(19) United States
(12) Patent Application Publication
(10) Pub. No.: US 2010/0140328 A1
(43) Pub. Date: Jun. 10, 2010

(54) METHOD AND APPARATUS FOR MAGNETIC IMPULSE WELDING OF SHEETS

(75) Inventor: Sven Ove Olsson, Trollhaettan (SE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/519,747

(22) PCT Filed: Dec. 18, 2007
(86) PCT No.: PCT/EP2007/064151

§ 371 Date: Feb. 15, 2010

(30) Foreign Application Priority Data
Dec. 18, 2006 (EP) 06026222.7

(51) Int. Cl. B23K 20/06

(52) U.S. Cl. 228/115; 228/3.1

(57) ABSTRACT

A first sheet, includes, but is not limited to at least one attachment region inclined at an angle to a sheet plane. The first sheet is arranged on a second sheet so that the attachment region of the first sheet is spaced at a distance from the second sheet. A magnetic field pulse is applied so as to cause a force on the attachment region in directions generally perpendicular to the first sheet plane and the second sheet plane so that the attachment region of the first sheet is driven against the second sheet with sufficient force to produce a cold-welded joint between the attachment region of the first sheet and the second sheet.

### CROSS-REFERENCE TO RELATED APPLICATIONS

This application is a U.S. National-Stage entry under 35 U.S.C. §371 based on International Application No. PCT/EP2007/064151, filed Dec. 18, 2007, which was published under PCT Article 21(2), and this application claims priority to European Application No. 06026222.7, filed Dec. 18, 2006, which are all hereby incorporated in their entirety by reference.

### TECHNICAL FIELD

The invention relates to a method and to apparatus for magnetic impulse welding of sheets, in particular, metallic sheets.

### BACKGROUND

Some welding techniques involve the application of heat to localized areas of two metallic members which results in a coalescence of the two metallic members and a welded joint. Pressure and/or a further filler metal may additionally be used. There are, however, some drawbacks to the use of these welding techniques. The application of heat can cause undesirable distortions and weaknesses to be introduced into the metallic members. Additionally, the surface finish of the welded area is often undesirably rough. Furthermore, reliable welded joints between components of dissimilar metallic materials are difficult to produce.

In order to mitigate some of these drawbacks, it is known from U.S. Pat. No. 6,234,375 to use magnetic impulse welding to join tubular members. While magnetic impulse welding may be used to join dissimilar materials such as steel and aluminum, the prior art magnetic impulse welding methods are inconvenient to use for joining metallic members in the form of sheets. The known methods and apparatus for magnetic impulse welding are, therefore, limited in the extent to which they can be used since complex structures, such as vehicle frames and vehicle body panels, often include components having a variety of forms, such as sheets, as well as tubular components.

A method and apparatus for magnetic impulse welding more suitable for joining metallic sheets is, therefore, desirable. In addition, other desirable features and characteristics will become apparent from the subsequent summary and detailed description, and the appended claims, taken in conjunction with the accompanying drawings and this background.

### SUMMARY

A method for magnetic impulse welding of sheets comprises providing a first metallic sheet and a second metallic sheet which are to be welded together. Each sheet has a sheet plane. The first metallic sheet comprises at least one attachment region which is inclined at an angle to the sheet plane of the first metallic sheet. The first metallic sheet is arranged on the second metallic sheet so that the attachment region of the first metallic sheet is spaced at a distance from the second metallic sheet. A magnetic field pulse is applied so as to cause a force on the attachment region of the first metallic sheet in directions generally perpendicular to the first sheet plane and to the second sheet plane so that the attachment region of the first metallic sheet is driven against the second metallic sheet with sufficient force to produce a cold welded joint between the attachment region of the first metallic sheet and the second metallic sheet.

The first metallic sheet and the second metallic sheet have a general planar form. However, the form may deviate from a theoretical plane, particularly in regions outside of the region of the sheets which to be joined, such as an edge seam for example.

The sheet plane is defined as a plane parallel to the general upper surface of the sheet, at least in the region in which the joint is desired. The general upper surface being generally planar apart from, in the case of the first sheet, the at least one attachment region which is inclined at an angle to the sheet plane.

This context, inclined at an angle is used to define an angle which is greater than about 0° and up to and including about 90° from the sheet plane. It should be understood, that the attachment region may include portions inclined at a plurality of angles to the sheet plane and may include a portion which is generally parallel to the sheet plane. The attachment region may have a general U-form, a hemispherical or a cone or a groove form for example.

At least one attachment region is positioned in at least one of the sheets to be joined in a region where a joint is desired. To form the cold welded joints between the attachment region of the first sheet and the second sheet, the first sheet is arranged on the second sheet. More particularly, a portion of the first sheet may overlap a portion of the second sheet to provide an overlapping joining region.

The first sheet may be in physical contact with the second sheet in regions outside of the attachment region. In other words, only the attachment region of the first sheet is positioned at a distance from the second sheet to provide a localized spacer between adjoining surfaces of the first sheet and the second sheet. Only the attachment region is driven at high speed by the force caused by the magnetic field pulse against the second sheet to produce a local explosive or impact weld. Consequently, a localized cold welded joint or spot weld is formed between the first sheet and the second sheet at the attachment region.

This is in contrast to other magnetic impulse welding techniques where a first tubular member is positioned concentrically within a second tubular member and at a distance from the second tubular member. A force is applied symmetrically around the overlapping members to form a continuous ring shaped joint which extends over essentially all of the overlapping portions.

A method by which localized attachment regions are welded by the force provided by a magnetic impulse is simple to use since it is not necessary to space the whole of the first sheet and the whole of the second sheet at a distance from another and to move the whole of the first sheet against second sheet at high velocity by applying the pulse of magnetic field to produce a cold-welded joint.

Regions of the first sheet outside of the attachment region and the second sheet may remain essentially stationary while the attachment region is moved by the force caused by the pulse of applied magnetic field.

The attachment region of the first sheet may be provided in a variety of forms. The attachment region may be provided as a bent edge of first sheet or in the form of a plastically deformed depression or protrusion in a surface of the first sheet. A plurality of attachment regions may be provided, typically spaced at intervals in the region to be joined. A cold welded joint is formed, by the magnetic impulse welding method described herein, between each of the plurality of attachment regions of the first sheet and the second sheet to provide a plurality of localized cold welded joints.

The plastically deformed depression may comprise a dimple, which may have a generally hemispherical or frustoconical form or the depression may comprise a groove. Since the depression is formed by plastic deformation of the sheet, the depression may also be described as a protrusion in the opposing surface. The attachment area or attachment areas of the first sheet may be spaced at a distance of about 2 mm to about 3 mm from the second sheet when the two sheets are arranged together before the cold welded joint is formed. The plastically deformed depression may have a diameter of about 2 mm to about 15 mm and a depth of about 0.5 mm to about 10 mm or a length of about 10 mm to about 200 mm, a width of about 2 mm to about 20 mm and a depth of about 0.5 mm to about 10 mm. Each sheet to be joined may have a thickness of about 0.5 mm to about 10 mm, for example.

The dimensions of the attachment areas may be selected depending on the lateral extent of the cold welded joint which is desired. The spacer distance provided by the attachment region may be selected to as to provide a desired impact speed between the attachment region of the first sheet and the second sheet.

In an embodiment, the attachment region extends to an edge of the first sheet. An example, a groove may extend from an edge of the first sheet inwardly. This arrangement has the advantage that as the plastically deformed attachment region is driven against the second sheet by the force caused by the magnetic field pulse, air and any other particles present in the gap between the attachment region of the first sheet and the second sheet may escape from the open end of the attachment region.

The force caused by the magnetic field pulse may be sufficient to drive the attachment region of the first sheet against the second sheet at a velocity of up to about 500 m/s. The velocity is selected so as to produce a reliable cold welded joint between the attachment region of the first sheet and the second sheet. The velocity required to produce a reliable cold welded joint depends on the material of the sheets which are to be joined and is selected accordingly.

The magnetic field may be applied from only one side of the overlapping metallic sheets. Alternatively, the magnetic field may be applied form two opposing sides of the two metallic sheets to be joined.

The magnetic field may be applied in directions generally parallel to the first sheet plane so as to cause a force in directions generally perpendicular to the first sheet plane in the region of the attachment region. The magnetic field may be provided by an electromagnet which is energized by a current pulse of up to about 500 kA or up to about 100 kA, for example. The current pulse may be provided by switching open an energized capacitor bank and may have a pulse length of about 20 to about 100 μs, for example.

The method and apparatus may be used to join sheets of any metal or alloy. The sheets are, therefore, metallic. A high electrical conductivity is advantageous in that larger currents are induced in the sheet which results in a greater force and a more efficient joining welding process.

In an embodiment, the first sheet and second sheet may comprise metals or alloys of the metals chosen from the group consisting of steel, aluminum and magnesium, in particular aluminum to aluminum and steel to steel. The first sheet and the second sheet may comprise the same metal or alloys or may comprise different metals or alloys of metals chosen from these groups. More particularly, a steel sheet may be joined to an aluminum sheet by the localized magnetic impulse welding method according to one of the embodiments described herein.

The method may be conveniently used to join metallic components in the form of sheets which are components of a vehicle body panel assembly, a vehicle chassis, a vehicle frame assembly or a vehicle exhaust system. These components are provided with at least one attachment region positioned locally where a localized joint is desired. The method may be used to join steel and aluminum components of car bodies.

In this context first metallic sheet and second metallic sheet may refer to the form of the component in a region or seam which is to be joined. The components may have a three-dimensional form, formed by deforming a sheet or panel which has a general sheet or panel plane, which extends in directions perpendicular to the general sheet plane, for example, a vehicle body panel. The regions of the first and second sheet which are to be joined, for example an edge seam, may be generally planar.

Apparatus for producing a cold welded joint between a first metallic sheet and a second metallic sheet comprises a support table. The support table comprises a support surface for supporting portions of the first sheet and of the second sheet positioned thereon, the first sheet being positioned on the second sheet during production of the cold welded joint. The apparatus further comprises means for generating a magnetic field pulse positioned adjacent the support surface of the support table and being adapted to produce a magnetic field in a directions generally parallel to the support surface of the support table and being adapted to cause a force in directions generally perpendicular to the support surface in order to drive an attachment region of the first sheet which is spaced at a distance from the second sheet against the second sheet so as to produce a cold welded joint between the attachment region of the first sheet and the second sheet.

The apparatus comprises a support table on which both the first sheet and second sheet are supported during the production of the cold welded joints. The apparatus is simple since additional means to space the first sheet and the second sheet apart from one another so that the first and second sheet may be forced together at high speed to form the cold welded joint are not required since a localized spacer region is provided by an attachment region provided in the first sheet. Consequently, the first sheet can be simply placed in physical contact with the second sheet on the support surface of the support table and the magnetic fields pulse applied so as to drive the attachment region of the first sheet against the second sheet and produce a cold welded joint between the attachment region of the first sheet and second sheet. Regions of the first sheet and the second sheet outside of the attachment region are not cold welded and remain largely stationary during the application of the magnetic pulse. These regions may be temporarily clamped to the support table so as to prevent undesired lateral movement of the pieces relative to one another during the production of the welded joint or joints.

The means for generating the magnetic field pulse may be movable in directions generally perpendicular to the support surface. This has the advantage that the means for generating the magnetic field can be backed off from the support surface to enable the first and second sheet to be positioned on the support surface and then moved towards the support surface for applying the magnetic field pulse. The magnetic field required to produce sufficient force to produce a cold welded joint may be reduced by positioning the means for generating the magnetic field pulse close to the upper surface of the attachment region.

The magnetic field pulse may be conveniently provided by an electromagnet. The apparatus may further comprise a current supply for the electromagnet and may further comprise a capacitor for providing a pulse of electric current to the electromagnetic. In this sense, a capacitor is not intended to be limited to a single object and maybe conveniently provided in the form of a capacitor bank. If a movable electromagnet is used, the current required to produce a particular magnetic field may be reduced by positioned the electromagnet in closer proximity to the attachment region.

### BRIEF DESCRIPTION OF THE DRAWINGS

The present invention will hereinafter be described in conjunction with the following drawing figures, wherein like numerals denote like elements, and

FIG. 1 illustrates an arrangement for magnetic impulse welding of sheets according to a first embodiment

FIG. 2 illustrates the arrangement after the production of the cold welded joint according to the first embodiment;

FIG. 3 illustrates an arrangement for magnetic impulse welding of sheets according to a second embodiment;

FIG. 4 illustrates the arrangement after the production of the cold welded joint according to the second embodiment; and

FIG. 5 illustrates apparatus for magnetic impulse welding of sheets.

### DETAILED DESCRIPTION

The following detailed description is merely exemplary in nature and is not intended to limit application and uses. Furthermore, there is no intention to be bound by any theory presented in the preceding background or summary or the following detailed description.

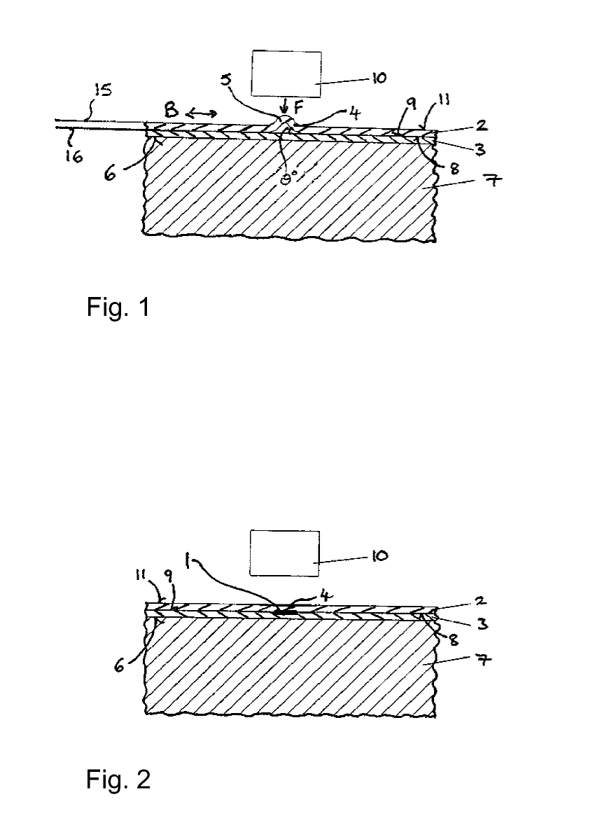

FIG. 1 and FIG. 2 illustrates the production of a localized cold welded joint 1 between a first metal sheet 2 and a second metallic sheet 3 by magnetic impulse welding according to a first embodiment of the invention. The first metallic sheet 2 is an aluminum sheet which comprises a plurality of attachment regions 4, of which one is illustrated, spaced at intervals in an edge region. Each attachment region 4 has the form of a hemispherical dimple 5 having a diameter of about 5 mm and a depth of about 2 mm which has been produced by plastic deformation of the first sheet 2. The dimple 5 may be produced by pressing the lower surface 9 to form a depression in the lower surface 9 and corresponding protrusion in the upper surface 11 of the first sheet 2. The second sheet 3 is a steel sheet. The aluminum sheet 2 and steel sheet 3 are components of a vehicle chassis.

The second steel sheet 3 is placed on a support surface 6 of the support table 7. The first aluminum sheet 2 is placed on the upper surface 8 of the second sheet 3 such that the lower surface 9 of the first sheet 2 is in physical contact with the upper surface 8 of the second sheet 3 in regions outside of the dimple or attachment region 4. The first metallic sheet 2 and second metallic sheet 3 each have a sheet plane 15, 16 which is generally parallel with the upper surface 6 of the support table 7. The dimple 5 provides a localized region of the first sheet 2 which is spaced at a distance from the upper surface 8 of the second sheet 3. The dimple 5 provides an attachment region 4 with at least portions inclined at an angle, θ, to the first sheet plane 15 as well as the second sheet plane 16.

A means 10 for applying a magnetic field pulse is positioned adjacent the first metallic sheet 2, more particularly, adjacent the upper surface 11 of the protruding surface of the attachment region 4 of the first metallic sheet 2.

In order to increase the force produced by the interaction of the applied magnetic field and the magnetic field induced in the first sheet 2 and second sheet 3, the sheet with the highest electrical conductivity is positioned directly adjacent to the magnet 10. Therefore, in this embodiment, the steel sheet 3 is placed on the support table 7 and the aluminum sheet 2 is placed on the steel sheet 3 so that it is directly adjacent to the magnet 10.

The means 10 for generating magnetic field pulse is provided in the form of an electromagnet which further comprises a power supply comprising a bank of capacitors, a high-speed switching system as well as the electrically conductive coil which are not illustrated in the drawings. The magnetic field pulse generating means is adapted to provide a magnetic field pulse in directions generally parallel to the first sheet plane 15 of the first metallic sheet 2 and the second sheet plane 16 of the second metallic sheet 3. The coil may be provided in the form of an E-shaped flat coil.

To produce a cold welded joint between the attachment region 4 of the first metallic sheet 2 and the second metallic sheet 3, the bank of capacitors is charged, the high-speed switch is activated and a current pulse of is applied to the coil. As an example, the current pulse may be about 100 kA for a time of about 50 μs. A high-density magnetic flux is generated by the coil, indicated in the drawings by B, in the plane of the first sheet 2 and second sheet 3. As a result, eddy currents are created in the first sheet 2 and, to a lesser extent, in the second sheet 3 since the first sheet 2 is shielding the second sheet 3. These induced eddy currents induce a magnetic field which interacts with the magnetic field of the coil resulting in a force, indicated in the drawings by F, to be created in directions generally perpendicular to the sheet plane and upper surface 11 of the first sheet 2 in the attachment region 4 of the first sheet 2. This force F drives the attachment region 4 of the first sheet 2 against the upper surface 8 of the second sheet 3 at a speed of up to about 500 m/s and an explosive or impact weld is produced at the interface between the lower surface 9 of the first sheet at attachment region 4 and the upper surface 8 second sheet 3. A localized or spot cold welded joint 1 is produced between the first sheet 2 and the second sheet 3 at the attachment region 4 which is illustrated in FIG. 2 as a black rectangle.

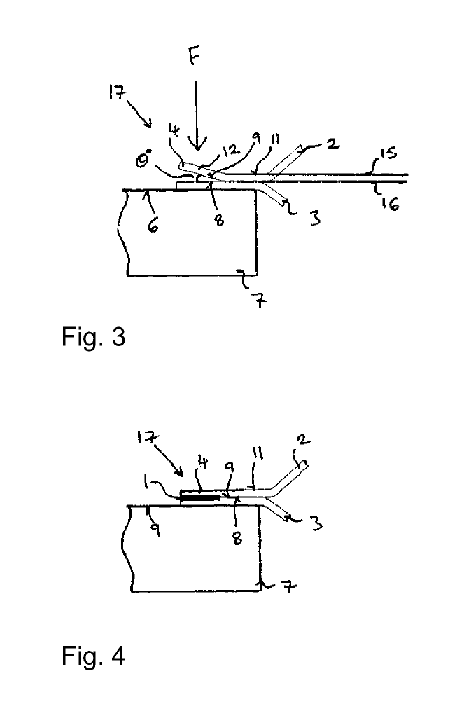

FIG. 3 and FIG. 4 illustrate the production of a cold welded joint between a first aluminum sheet 2 and a second steel sheet 3 according to a second embodiment of the invention. The same reference numbers are used to indicate the same components or components have a similar function throughout the description.

According to the second embodiment, the attachment region 4 is provided in the form of a bent edge region 12 of the first sheet 2. The edge region 12 of the first sheet 2 is, therefore, positioned at inclined angle, θ, to the first sheet plane 15 and the second sheet plane 16. The inclined edge region 12 has a length of 30 mm and the distal end is positioned approximately 3 mm above the upper surface 8 of the second sheet 3. As is illustrated in FIG. 3 and FIG. 4, the form of the first sheet 2 and second sheet 3 may deviate from the sheet plane 15, 16 in regions outside of the joint region 17. In the joint region 17, the first sheet plane 15 and second sheet plane 16 are positioned parallel to each other and the lower surface 9 of the first sheet is in physical contact with the upper surface 8 of the second sheet apart from in the attachment region 4.

Similarly to the first embodiment, a magnetic field pulse is applied which produces a force F in a directions generally perpendicular to the support surface 6 of the support table 7 on the first sheet 2 driving the attachment region 4 against the second sheet 3 at a sufficient velocity to produce a cold weld 1 between the first sheet 2 and the second sheet 3 in the region of the attachment region 4. The distal end of the limb 12 providing the attachment region 4 is open at the edge of the first sheet 2 so that air and other particles present in the gap between the first sheet 2 and the second sheet 3 in the attachment region 4 may escape from the interface during the production of the cold welded region.

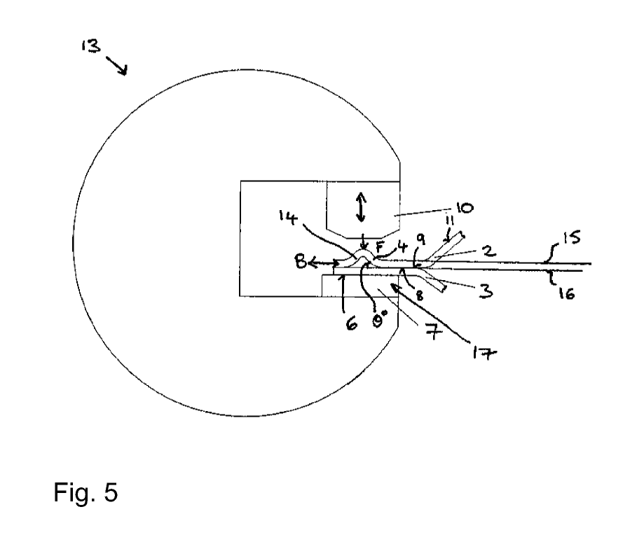

FIG. 5 illustrates a side view of apparatus 13 for producing a cold welded joint between two sheets 2, 3 by magnetic impulse welding. The apparatus 13 has a general C-shape and comprises a support table 7 and electromagnet 10 positioned adjacent the support surface 6 of the support table 7. The first metallic sheet 2 and second metallic sheet 3 are supported on the support table 7 during the welding process. The second sheet 3, which is generally planar, is positioned on the upper surface 6 of the support table 7 and the first sheet 2 is positioned on the second sheet 3 so that an attachment region 4 of first sheet is spaced at a distance from the upper surface 8 of second sheet 3. In this embodiment, a plurality of attachment regions 4, of which one is illustrated, are provided in the form of a groove 14 which extends to an edge of the first sheet 2 and is, therefore, open at this end. Each groove has a length of about 50 mm, depth of about 2.5 mm and a width of about 4 mm for example.

The electromagnet 10 is movable in directions generally perpendicular to the upper surface 6 of the support table 7 and relative to the upper surface 6 of the support table 7 as indicated by the arrows. The electromagnet 10 is adapted to produce a magnetic field, B, in directions generally parallel to be upper surface 6 of the support table 7 and generally parallel to the sheet plane of the first metallic sheet 2 and of the second metallic sheet 3. The pulse of magnetic field induces eddy currents in the first metallic sheet 2 and second metallic sheet 3 producing a magnetic field which interacts with the applied magnetic field so as to create a force, F, in a directions generally perpendicular to the support surface 6 and generally perpendicular to be first sheet plane and second sheet plane. This force causes the attachment region 4 to be driven at high velocity against the upper surface 8 of the second sheet 3 to create a localized cold-welded joint at the attachment region 4 between the lower surface 9 of the attachment region 4 of the first sheet 2 and the upper surface 8 of the second metallic sheet 3.

The electromagnet 10 may be moved upwards away from the support surface 6 in order to positioned the first sheet 2 and second sheet 3 conveniently on the support table 7. The electromagnet 10 may then be lowered in a direction towards the support surface of the support table 7 and be positioned at a short distance adjacent the first metallic sheet 2, for example about 1 mm, when the magnetic field pulse is generated. This enables a greater magnetic field to be applied for a given current to the first metallic sheet 2 and second metallic sheet 3 using a lower current due to the close proximity of the electromagnet 10 to the first sheet 2 and second sheet 3 which are to be welded together. A larger magnetic field results in a larger force and higher impact velocity. The electromagnet is advantageously positioned as close as possible to the upper surface 11 of the first sheet 2 so as to subject the first sheet 2 to the highest possible applied magnetic field pulse.

The first metallic sheet 2 and second metallic sheet 3 may be joint together by a number of localized or spot welds fabricated by a magnetic impulse welding method according to one of the embodiments described herein. The first sheet 2 may be provided with a plurality of attachment regions 4, according to one of the embodiments described, which are positioned at intervals along a region, such as a seam, which is to be joined in an overlapping manner to the second metallic sheet 3. A magnetic field pulse may be applied to each of the attachment regions 4 in turn so as to drive the attachment region 4 against the second sheet 3 thus creating a plurality of localized cold welded joints 1 between the first metallic sheet 2 and second metallic sheet 3.

The apparatus 13 may be stationary or may move, for example by the use of a robot or robot carried welding fixture. A stationary or mechanically indexed tool may perform the welding of the sheets that are located in a stationary fixture. Alternatively, a stationary tool performs welding of the sheets which are located in a robot carried fixture. In yet another alternative, a robot carried C-shaped welding unit is positioned to weld sheets located in a stationary fixture. In each case, the current pulse is released, generating a magnetic field in the coil, the local depression is flattened and driven against the second sheet. The material of the first sheet locally hits the second sheet with high energy creating a local weld. The tool is then moved to another attachment region position and the welding process repeated.

In further embodiments not illustrated in the figures, the second metallic sheet 3 is also provided with at least one attachment region according to one of the embodiments described herein. The attachment region of the second sheet 2 may be positioned so as to align with an attachment region of the first sheet. This may be used to create a larger local gap or space and a higher impact velocity.

The surface finish of the joint fabricated by an embodiment of the invention is very high and may be superior to that achieved by spot welding since deformation caused by high temperatures and the use of additional filler materials is avoided. Additionally, a high surface finish can be provided for a joint between steel and aluminum which is considerably better than the surface finish provided by the clinching and self piercing rivets frequently used to join steel components to aluminum components.

The method is also fast and convenient as a step in which the sheets to be joined are spaced from one another is avoided. The method may be used for volume manufacture, such as the volume manufacture of car bodies. Since mixed materials, in particular, steel and aluminum, may be conveniently joined, the method is also suitable for the volume manufacture of mixed car bodies in which components traditionally made of steel are replaced by aluminum in order to save weight and improve fuel efficiency.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for magnetic impulse welding of a first metallic sheet and a second metallic sheets, comprising the steps of:
welding thee first metallic sheet to the second metallic, each of the first metallic sheet and the second metallic sheet having a sheet plane and the first metallic sheet comprising an attachment region inclined at an angle to the sheet plane;
arranging the first metallic sheet on the second metallic sheet so that the attachment region of the first metallic sheet is spaced at a distance from the second metallic sheet;
applying a magnetic field pulse so as to cause a force on the attachment region in a directions generally perpendicular to the sheet plane of the first metallic sheet and the second metallic sheet so that the attachment region of the first metallic sheet is driven against the second metallic sheet with a force to produce a cold-welded joint between the attachment region of the first metallic sheet and the second metallic sheet.

2. The method according to claim 1, wherein a region of the first metallic sheet outside of the attachment region and the second metallic sheet remain essentially stationary while the attachment region is moved by the force.

3. The method according to claim 1, wherein the second metallic sheet comprises second attachment region inclined at an angle to the sheet plane.

4. The method according to claim 1, wherein the attachment region is provided as a bent edge.

5. The method according to claim 1, wherein a plurality of attachment regions are provided, each of the plurality of attachment regions being a plastically deformed depression in a surface of the first metallic sheet.

6. The method according to claim 5, wherein the plastically deformed depressions comprise a dimple.

7. The method according to claim 1, wherein the attachment area of the first sheet is spaced at a distance of about 0.5 mm to about 10 mm from the second metallic sheet.

8. The method according to claim 5, wherein the plastically deformed depression has a diameter of about 2 mm to about 15 mm and a depth of about 0.5 mm to about 10 mm.

9. The method according to claim 5, wherein the plastically deformed depression has a length of about 10 mm to about 200 mm, a width of about 2 mm to about 20 mm and a depth of about 0.5 mm to about 10 mm.

10. The method according to claim 1, wherein the attachment region extends to an edge of the first metallic sheet.

11. The method according to claim 1, wherein the force is sufficient to drive the attachment region of the first metallic sheet against the second metallic sheet at a speed of up to about 500 m/s.

12. The method according to one of the claim 1, wherein the magnetic field is applied from only one side of the first metallic sheet.

13. The method according to claim 1, wherein the magnetic field is applied from two opposing sides of the first metallic sheet.

14. The method according to claim 1, wherein the magnetic field is applied in directions generally parallel to the sheet plane.

15. The method according to claim 1, wherein the magnetic field is provided by an electromagnet, the electromagnet being energized by a current pulse of up to about 500 kA.

16. The method according to claim 1, wherein the first metallic sheet and the second metallic sheet comprise a material chosen from a group consisting of steel, aluminium and magnesium.

17. The method according to claim 1, wherein the first metallic sheet and the second metallic sheet comprise different materials of metals chosen from the groups consisting of steel, aluminium and magnesium.

18. The Method of claim 1, wherein the steps of the method are repeated at least once to produce a plurality of cold-welded joints between the first metallic sheet and the second metallic sheet.

19. The method according to claim 1, wherein the first metallic sheet and the second metallic sheet are components of a vehicle body panel assembly, a vehicle chassis, a vehicle frame assembly or a vehicle exhaust system.

20. (canceled)

21. (canceled)

22. An apparatus for producing a cold-welded joint between a first metallic sheet and a second metallic sheet, comprising:
a support table having a support surface for supporting portions of the first metallic sheet and the second metallic sheet positioned on the support table, the first metallic sheet being positioned on the second metallic sheet during the production of the cold-welded joint;
a generator for generating a magnetic field pulse positioned adjacent the support surface of the support table and being adapted to produce a magnetic field in a direction generally parallel to the support surface of the support table and adapted to cause a force in directions generally perpendicular to the support surface to drive an attachment region of the first metallic sheet which is spaced at a distance from the second metallic sheet against the second metallic sheet so as to produce the cold-weld joint between the attachment region of the first metallic sheet and the second metallic sheet.

23. The apparatus according to claim 22, wherein the generator is movable in directions generally perpendicular to the support surface.

24. The apparatus according to claim, wherein the magnetic field source is an electromagnet.

25. The apparatus according to claim 24, further comprising a current supply for the electromagnet.

26. The apparatus according to claim 24, further comprising a capacitor for providing a pulse of an electric current to the electromagnet.
